(19) United States
(12) Patent Application Publication
(10) Pub. No.: US 2005/0111735 A1
(43) Pub. Date: May 26, 2005

(54) Video based handwriting recognition system and method

(75) Inventor: Vadim Sheinin, Yorktown, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 10/719,705

(22) Filed: Nov. 21, 2003

(51) Int. Cl. G06K 9/00; G09G 5/00

(52) U.S. Cl. 382/187; 382/119; 345/173

(57) ABSTRACT

A system and method of on-line handwriting recognition includes screen pen data to be combined with other information obtained through the usage of built-in digital camera, such as pen tilt parameter information. The method and system provide a low-cost solution for achieving better handwriting recognition quality for consumer platforms such as PDA. Camera being built-in does not increase the cost of the solution—the only added component is software-based pattern recognition algorithm that extracts non screen-related pen information.

### BACKGROUND OF THE INVENTION

1. Field of the Invention

The present invention relates generally to handwriting recognition systems and methods and, particularly to handwriting recognition systems and methods for pervasive devices.

2. Description of the Prior Art

One of the most promising methods of interacting with small portable computing devices such as Personal Digital Assistant (PDA), smart phones, and like wireless or wired pervasive devices, is by handwriting recognition. In contrast to the automatic processing of forms or postal addresses, where an image of the handwritten text is acquired and processed off-line, in handwriting recognition, the movement of pen is captured directly during the writing process (real-time). In order to obtain this “on-line” handwriting data, however, special input devices including touch sensitive pads together with special “smart” pens with built-in intelligence for obtaining and processing tilt information are necessary.

The quality of the recognition process is very important for the acceptance of handwriting recognition as a means of input. In some cases, imperfect quality of recognition may be just an inconvenience, whereas in other cases, it may preclude usage of the technology at all. Therefore, any way to improve upon the quality of recognition is welcome. Furthermore, one that improves upon the quality of recognition at a low cost is advantageous as these devices become much more attractive to cost conscience consumers.

One of the applications of handwriting recognition today is signature recognition, most typically for retail applications, and the like, etc. In these applications, the underlying method is based upon relatively smart and expensive pen device having intelligence for generating output parameters such as tilt etc., which are additionally utilized in the recognition algorithms employed by the pervasive device. When a typical pervasive device such as an average PDA is used, typically the only pen used is a common plastic stylus. Given the price of a PDA at about 300$, for example, it is not cost effective to add an expensive smart pen at about 80$, for instance.

It would thus be desirable to provide a simple stylus device that is able to obtain the precision and quality of recognition of smart pen devices.

In conventional handwriting recognition, e.g., a hybrid handwriting recognition system, there are implemented steps of: responding to a handwriting input from a user, and dynamically generating time ordered, stroke information which are used to determine a most probable character that the dynamic, time ordered stroke information is intended to represent. Such a system is described in a reference U.S. Pat. No. 6,011,865 entitled “Hybrid on-line handwriting recognition and optical character recognition system.”

An exemplary system 10 currently in use for handwriting recognition, e.g. for retail applications, is now described with respect to FIG. 1 that depicts an external smart pen device 15, a writing surface 18, and a handwriting recognition processing block 20 implementing recognition processes 22 running on a computer platform. Pen position information as well as other pen information such as tilt parameter information, etc., are extracted from the smart pen and writing surface 18 and transmitted through link 25 to an executing handwriting recognition process 22. The algorithm in use is on-line type of recognition using dynamic information from the pen. As mentioned above, price constraints simply will not permit usage of the relatively expensive smart pen device 15 and a handwriting recognition block 20 to run on pervasive platform such as a PDA.

As mentioned, current PDA devices are equipped with a plastic stylus with no intelligence attached. The only function of the stylus is to press upon a touch sensitive PDA display surface to produce dynamic information. FIG. 2 illustrates the conventional PDA device 30 including a touch screen 32 for generating dynamic stylus handwriting information that is fed through an internal link 35 into handwriting recognition block 40 that runs on the same CPU as the rest of the PDA software. An obvious disadvantage of the approach of the system 30 depicted in FIG. 2, is a lack of additional pen information such as tilt as compared with the system described with respect to FIG. 1.

In other types of recognition systems, a pure digital camera input may be used for the sake of recognition, however the processing and results may not be as precise.

As many pervasive devices are increasingly entering the market equipped with an embedded digital camera of relatively high resolution (e.g., implementing VGA), it would be advantageous to utilize the digital camera for providing digital video data for use in the handwriting recognition process in such pervasive devices.

It would thus be highly desirable to provide a handwriting recognition system and method for pervasive devices that includes a low cost digital video camera functioning to provide more handwriting information from a low cost stylus pen equipped with the device, and use this information together with pen position for the purpose of improving handwriting recognition.

### SUMMARY OF THE INVENTION

It is an object of the present invention to provide a low-cost solution for improving handwriting recognition in pervasive devices.

It is another object of the present invention to provide a low-cost solution for improving handwriting recognition in pervasive devices that includes utilizing a digital camera: embedded in the device to obtain real-time information corresponding to movement of the simple stylus pen equipped with the pervasive device during use, and utilize this information together with stylus position information for the purpose of improving handwriting recognition.

It is a further object of the present invention to provide a pervasive device such as a PDA, smart phone, or other wireless or wired pervasive device that includes a low-cost solution for improving handwriting recognition, and particularly, a method and system that enables an embedded digital camera to obtain more information from the stylus pen used by the writer and process this information together with pen position for the purpose of improving handwriting recognition in applications for such pervasive devices. Such pervasive devices are equipped with processing capability including implementation of handwriting recognition algorithms that receive data input obtained from a digital camera embedded in the device in addition to commonly obtained pen stylus position information for the purpose of improving handwriting recognition.

According to a first aspect of the invention, there is provided a system and method for use in a pervasive device that implements an embedded digital camera together with a simple stylus, and processing capability for generating additional information, such as tilt etc. This video information is processed by a particular algorithm that is able to extract tilt and/or other parameters needed for handwriting recognition. The camera is particularly installed in such a manner so as to capture a plane which is perpendicular to the PDA screen plane. The tilt extraction is possible by virtue of combining known pen geometry, digital camera output and touch screen output being coordinates of the pen.

According to another aspect of the invention, there is provided a system and method for use in a pervasive device that implements an embedded digital camera together with a simple stylus, and processing capability implementing handwriting recognition algorithms, wherein handwriting recognition algorithms may be the same ones in use for retail applications. The only difference will be the source of tilt information—instead of getting this information from an external pen it will come from the camera. An image/pattern recognition algorithm is implemented to first process camera output data, e.g., low-frequency video information, extract pen tilt data, and feed it to a handwriting recognition algorithm that uses tilt to improve the quality of the handwriting recognition.

According to a further aspect of the invention, there is provided a pervasive device, such as a PDA, that implements an embedded digital (built-in) camera together with a simple stylus, and processing capability implementing handwriting recognition algorithms for providing precise handwriting recognition.

### BRIEF DESCRIPTION OF THE DRAWINGS

Further features, aspects and advantages of the structures and methods of the present invention will become better understood with regard to the following description, appended claims, and accompanying drawings where:

FIG. 1 depicts a conventional external smart pen-based handwriting recognition system on a touch screen for use in retail applications;

FIG. 2 depicts a conventional PDA equipped with a stylus for use in handwriting recognition on a touch screen;

FIG. 3 depicts a PDA device equipped with an embedded digital camera utilized for generating information used in the handwriting recognition system and methodology of the invention;

FIG. 4 depicts a flow chart implementing the handwriting recognition system with additional information obtained from the embedded camera;

FIG. 5 depicts a PDA device implementing a touch screen, a simple stylus, and an embedded digital camera utilized for generating information used in the handwriting recognition system and methodology of the invention;

FIG. 6 depicts a geometry for generating stylus coordinates used in calculating stylus tilt information; and,

FIG. 7 depicts a process sequence for calculating the tilt according to the methodology of the invention.

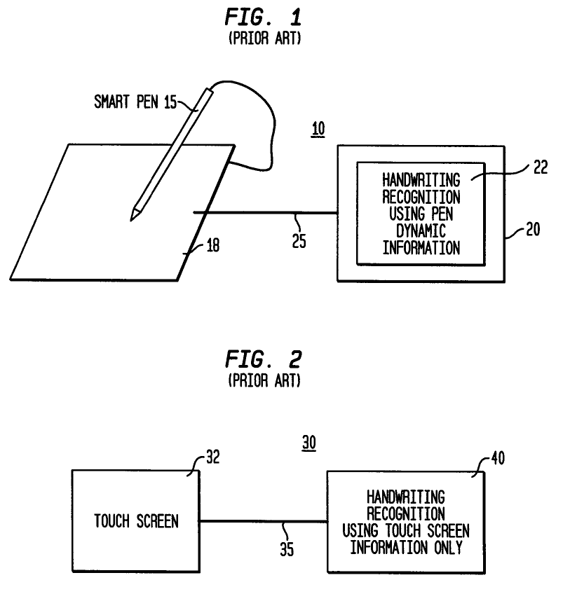

### DETAILED DESCRIPTION OF THE PREFERRED EMBODIMENT

The present invention is directed to a system and method for improving handwriting recognition for PDA device applications equipped with a plastic stylus.

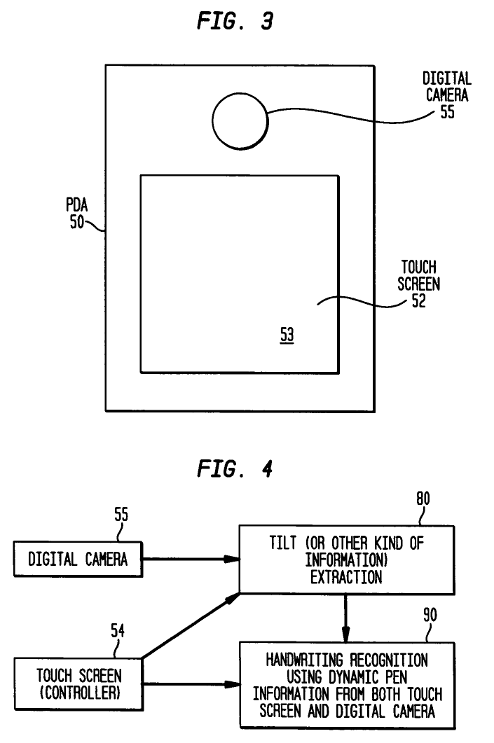

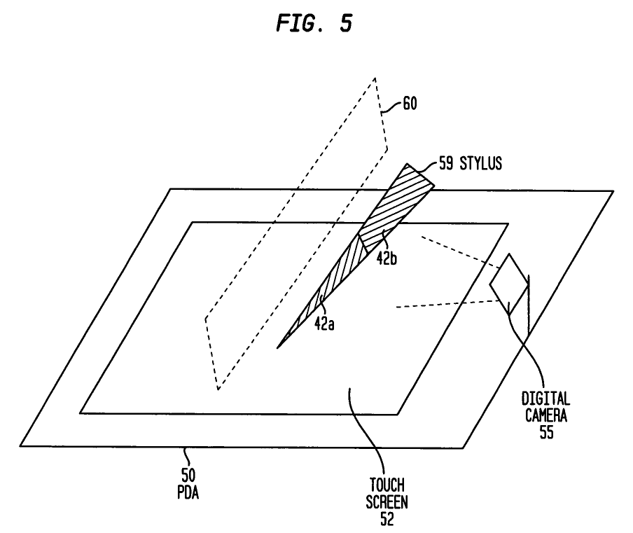

FIGS. 3 and 5 illustrate a PDA device 50 having a digital touch screen device 52 including a writing surface 53 for a simple stylus pen 59, and a built-in digital camera device 55 having functionality for generating dynamic video data output corresponding to stylus movement when manipulated by a user writing on the touch screen surface. A processing unit (CPU) of a PDA device or like pervasive device receives data obtained from the digital touch screen 52 and output from the digital camera device 55 and implements algorithms for performing handwriting recognition based on both types of information. The embedded digital camera 55 is preferably mounted in such a position and angle so as to capture video images along a plane that is perpendicular to the plane of touch screen surface 53 and of a range advantageous to capture handwriting anywhere on the touch screen surface. The conventional stylus pen 59 when used in a handwriting application will be located in such a plane.

As shown in FIG. 5, the PDA or like pervasive device 50 includes a digital camera 55 capable of capturing images in a plane 60 perpendicular to screen 52 and by virtue of this, processes are implemented for dynamically calculating tilt information associated with the stylus movement during a user's handwriting and outputting the same for use in the handwriting recognition algorithm. In the following description, stylus tilt is shown-to be integral in handwriting recognition. The same scheme can be applicable for other kinds of information to be extracted by means of digital camera and used in handwriting recognition algorithm.

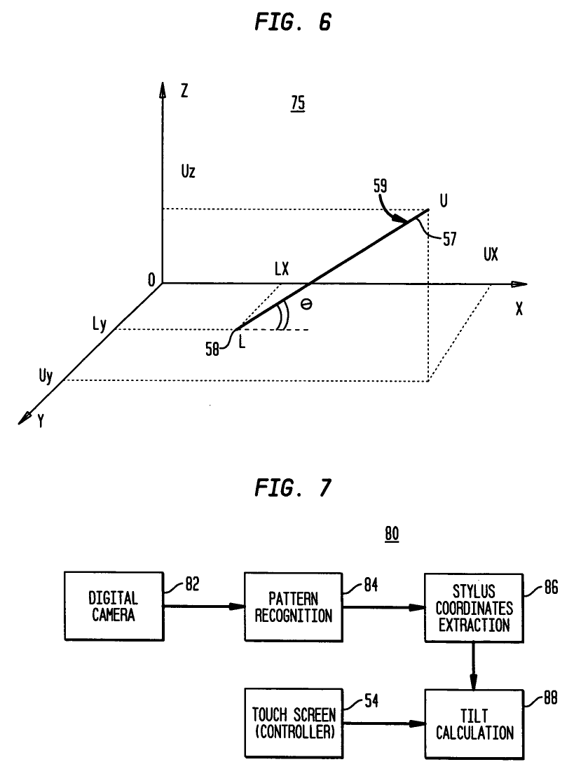

As shown in FIG. 6, the tilt angles, e.g. an angle theta “θ”, associated with the tilt of the stylus are calculated from the output video images of the stylus 59 along the planes as depicted in the figure. Particularly, FIG. 6 depicts a defined coordinate system, e.g., an OXYZ system 75, including an OYX plane representing the PDA touch screen surface 53 and, a ZOX plane “equal” to the camera image. Given that the lower end 58 of stylus (L) touches the PDA screen touch screen surface 53 and has coordinates Lx, Ly, (Lz=0) and whereas an upper end 57 of stylus (U) includes coordinates Ux, Uy, and Uz, from the geometry of the stylus 59, the length of the stylus may be calculated according to equation (1) as follows:
Length_Of_Stylus=sqrt((Lx-Ux)\hat{ }2+(Ly−Uy)\hat{ }2+(Lz−Uz)\hat{ }2) (1)

It is given that Lz=0 because lower end of the stylus L touches the PDA screen and, coordinates Ly and Lx are known from the screen controller device that controls touch screen data acquisition. Further, as a result of processing the digital video camera images, the lengths Ux and Uz may be extracted. Thus, simple geometry dictates that if Uy is known, then stylus tilt may be calculated. From equation (1), Uy may easily be determined given all this information. Thus, knowing Uy, the tilt angle of the stylus is easily calculated.

FIG. 7 depicts a process sequence 80 for calculating the tilt according to the methodology of the invention. In order to calculate the tilt, there are three stages as shown in FIG. 7. At a first step 82, information from digital camera device is fed into a pattern recognition block 84 where a pattern recognition task is performed. The function of pattern recognition block 84 is to perform processing to extract stylus image from the video images captured by the embedded camera. To facilitate in this task, the simple plastic stylus is provided with recognition enhancements so that portions of the stylus may be easily recognized and data easily extracted for processing. For instance, as shown in FIG. 5, the stylus may be designed to include various colored segments 42a, 42b to form a structure that is known to the algorithm of pattern recognition processing block 84. Once the stylus pattern is extracted, a third step 86 calculates coordinates of the stylus, Ux and Uz as described herein with respect to FIG. 6. Further, these coordinates together with the coordinates of the lower end 58 of the stylus generated by the touch screen controller device 54 are processed in processing step 88 where actual stylus tilt information is computed.

FIG. 4 illustrates the whole data flow of the handwriting recognition process for a pervasive device: an embedded and specifically mounted digital camera 55 captures the stylus image and outputs it into a processing block 80 which is responsible for tilt computation as described with respect to FIG. 7. As described, the tilt computation block 80 receives input from the touch screen controller 54 to obtain real-time coordinates of the stylus low end. The output of the tilt computation block/method 80 is fed into a further processing block 90 together with the stylus coordinate data output from the touch screen controller 54. The processing block 90 performs the actual handwriting recognition task having inputs from both camera and touch screen controller.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

1. A dynamic handwriting recognition system for a pervasive device comprising:
a touch screen device;
a stylus means enabling a user to write on said touch screen, said touch screen generating dynamic information associated with stylus writing;
a digital image capture means mounted in said pervasive device for obtaining images of said stylus as said user writes on said touch screen;
means for processing said obtaining images and extracting non screen-related information associated with stylus manipulation by said user; and
handwriting recognition means receiving both said dynamic touch screen information and extracted non touch screen-related information from said processed images for recognizing writing of said user, wherein improved handwriting recognition is achieved.

2. The dynamic on-line handwriting recognition system as claimed in claim 1, wherein said extracted non screen-related information include tilt parameters associated with stylus manipulation.

3. The dynamic handwriting recognition system as claimed in claim 1, wherein said pervasive device comprises a Personal Digital Assistant (PDA) device.

4. The dynamic handwriting recognition system as claimed in claim 2, further including a touch screen control device for generating coordinates of said stylus writing upon said touch screen.

5. The dynamic handwriting recognition system as claimed in claim 2, wherein said digital image capture means obtains images in a plane perpendicular to a plane defined by said touch screen device.

6. The dynamic handwriting recognition system as claimed in claim 4, wherein said pervasive device implements pattern recognition means for extracting said non touch screen-related pen information.

7. The dynamic handwriting recognition system as claimed in claim 6, wherein said stylus means includes elements enabling recognition by said pattern recognition means.

8. The dynamic handwriting recognition system as claimed in claim 7, wherein said elements enabling pattern recognition includes colored segments in a structure known to said pattern recognition means.

9. A method for dynamically performing handwriting recognition in a pervasive device including a touch screen device and a stylus means enabling a user to write on said touch screen device, said method comprising the steps of:
a) generating dynamic information associated with stylus writing;
b) mounting a digital image capture means in said pervasive device that is adapted to obtain images of said stylus as a user writes on said touch screen;
c) processing said obtaining images and extracting non screen-related information associated with stylus manipulation by said user; and
d) recognizing writing of said user utilizing both said dynamic touch screen information and extracted non touch screen-related information from said processed images, wherein improved handwriting recognition is achieved.

10. The method for dynamically performing handwriting recognition as claimed in claim 9, wherein said extracted non screen-related information include tilt parameters associated with stylus manipulation.

11. The method for dynamically performing handwriting recognition as claimed in claim 9, wherein said pervasive device comprises a Personal Digital Assistant (PDA) device.

12. The method for dynamically performing handwriting recognition as claimed in claim 10, wherein step a) of generating dynamic information includes the step of generating coordinates of said stylus writing upon said touch screen.

13. The method for dynamically performing handwriting recognition as claimed in claim 10, wherein said digital image capture means is mounted to obtain images in a plane perpendicular to a plane defined by said touch screen device.

14. The method for dynamically performing handwriting recognition as claimed in claim 12, wherein said processing step c) includes implementing pattern recognition means for extracting said non touch screen-related pen information.

15. The method for dynamically performing handwriting recognition as claimed in claim 14, further including the step of facilitating stylus recognition by a pattern recognition device.

16. The method for dynamically performing handwriting recognition as claimed in claim 15, wherein said stylus recognition is facilitated by including colored segments in said stylus that is known to said pattern recognition device.

17. A pervasive device comprising:
a touch screen device having a handwriting surface;
a stylus means enabling a user to write on said touch screen surface, said touch screen device generating dynamic information associated with stylus writing;
a digital image capture means mounted in said pervasive device for obtaining images of said stylus as said user writes on said handwriting surface;
a means for processing said obtaining images and extracting non screen-related information associated with stylus manipulation by said user; and
a handwriting recognition means receiving both said dynamic touch screen information and extracted non touch screen-related information from said processed images for recognizing writing of said user, wherein improved handwriting recognition for said device is achieved.

18. The pervasive device as claimed in claim 17, wherein said extracted non screen-related information include tilt parameters associated with stylus manipulation.

19. The pervasive device as claimed in claim 19, further including a touch screen control device for generating coordinates of said stylus writing upon said touch screen.

20. The pervasive device as claimed in claim 18, wherein said digital image capture means obtains images in a plane perpendicular to a plane defined by said touch screen device.

21. The pervasive device as claimed in claim 20, wherein said pervasive device implements pattern recognition means for extracting said non touch screen-related pen information.

22. The pervasive device as claimed in claim 21, wherein said stylus means includes elements enabling recognition by said pattern recognition means.

23. The pervasive device as claimed in claim 22, wherein said elements enabling pattern recognition includes colored segments in a structure known to said pattern recognition means.
